(19) United States
(12) Patent Application Publication
(10) Pub. No.: US 2018/0310130 A1
(43) Pub. Date: Oct. 25, 2018

(54) METHOD AND APPARATUS FOR TRACKING POSITION USING PHASE INFORMATION

(71) Applicant: LG ELECTRONICS INC., Seoul (KR)

(72) Inventors: Myeongjin KIM, Seoul (KR); Sangrim LEE, Seoul (KR); Dongkyu KIM, Seoul (KR)

(73) Assignee: LG ELECTRONICS INC., Seoul (KR)

(21) Appl. No.: 15/867,564

(22) Filed: Jan. 10, 2018

Related U.S. Application Data
(60) Provisional application No. 62/488,065, filed on Apr. 21, 2017.

(51) Int. Cl. H04W 4/02; G01S 5/04; G01S 5/06; G01S 5/02

(52) U.S. Cl. CPC H04W 4/023; G01S 5/0294; G01S 5/06; G01S 5/04

(57) ABSTRACT

In an aspect of the present invention, provided is a method for measuring a position of a mobile device by reference devices in a wireless communication system. In this case, the method may include: receiving, by a first reference device, reference signals at first and second frequencies from the mobile device; obtaining first phase difference information based on the reference signals received at the first and second frequencies; receiving, by the first reference device, second phase difference information from a second reference device; and measuring the position of the mobile device based on the first and second phase difference information.

Pursuant to 35 U.S.C. § 119(e), this application claims the benefit of U.S. Provisional Patent Application No. 62/488,065, filed on Apr. 21, 2017, the contents of which are hereby incorporated by reference herein in its entirety.

### BACKGROUND OF THE INVENTION

### Field of the Invention

The present invention relates to a wireless communication system, and more particularly, to a method and apparatus for tracking a position using phase information.

### Discussion of the Related Art

Wireless access systems have been widely deployed to provide various types of communication services such as voice or data. In general, a wireless access system is a multiple access system that may support communication of multiple users by sharing available system resources (e.g., a bandwidth, transmission power, etc.). For example, multiple access systems include a Code Division Multiple Access (CDMA) system, a Frequency Division Multiple Access (FDMA) system, a Time Division Multiple Access (TDMA) system, an Orthogonal Frequency Division Multiple Access (OFDMA) system, a Single Carrier Frequency Division Multiple Access (SC-FDMA) system, and a multi carrier frequency division multiple access (MC-FDMA) system.

3GPP LTE (3rd Generation Partnership Project Long Term Evolution) system is designed with a frame structure having a TTI (transmission time interval) of 1 ms and data requirement latency time for a video application is 10 ms. Yet, with the advent of a new application such as real-time control and tactile internet, 5G technology in the future requires data transmission of lower latency and it is anticipated that 5G data requirement latency time is going to be lowered to 1 ms. The 5G technology requires an eNB to have more UE connectivity and it is anticipated that the connectivity required by the 5G is going to be increased up to maximum 1,000,000/km2.

As more communication devices require greater communication capacity, necessity for mobile broadband communication, which is enhanced compared to a legacy radio access technology (RAT), is emerging. Moreover, discussion on a communication system to be designed in consideration of a service/UE sensitive to reliability and latency is in progress. Introduction of a next generation radio access technology (RAT) is being discussed in consideration of the enhanced mobile broadband communication (eMBB), the massive MTC (mMTC), URLLC (ultra-reliable and low latency communication), and the like. In the following, for clarity, the technology is referred to as a New RAT.

Recently, utilization of a drone is increasing and discussion on methods of efficiently performing communication between a drone and legacy communication devices is in progress. For example, a drone may correspond to a flying object filed by a control signal of a radio wave and a device performing communication.

### SUMMARY OF THE INVENTION

Accordingly, an object of the present invention is to provide a method and apparatus for tracking a position using phase information in a wireless communication system

Another object of the present invention is to provide a method for measuring a position by considering a range and phase relationship between signals.

A further object of the present invention is to provide a method for performing position measurement based on phase difference of arrival (PDOA).

According to an embodiment of the present invention, in a wireless communication system, a method for measuring a position of a mobile device by a reference device in a wireless communication system, the method comprising: receiving, by a first reference device, reference signals at first and second frequencies from the mobile device; obtaining first phase difference information based on the reference signals received at the first and second frequencies; receiving, by the first reference device, second phase difference information from a second reference device; and measuring the position of the mobile device based on the first and second phase difference information.

In addition, according to an embodiment of the present invention, in a wireless communication system, a first reference device for measuring a position of a mobile device in a wireless communication system, the reference device comprising: a receiver configured to receive a signal; a transmitter configured to transmit a signal; and a processor controlling the receiver and transmitter, wherein the processor is configured to: receive reference signals at first and second frequencies from the mobile device using the receiving mode, obtain first phase difference information based on the reference signals received at the first and second frequencies, receive second phase difference information from a second reference device using the receiving mode, and measure the position of the mobile device based on the first and second phase difference information.

Moreover, the following items can be commonly applied to a method and apparatus for measuring a position in a wireless communication system.

According to an embodiment of the present invention, the second reference device receives the reference signals at the first and second frequencies from the mobile device, and the second reference device obtains the second phase difference information based on the reference signals received at the first and second frequencies.

According to an embodiment of the present invention, when a distance between the first reference device and the mobile device has a first value and a distance between the second reference device and the mobile device has a second value, a difference between the first and second values is determined based on the first and second phase difference information.

According to an embodiment of the present invention, the position of the mobile device is determined based on the difference between the first and second values.

According to an embodiment of the present invention, each of the reference signals is a reference signal for measuring a distance.

According to an embodiment of the present invention, the first phase difference information is information generated based on a difference between the first and second frequencies.

According to an embodiment of the present invention, the reference device is a device with a fixed location.

According to an embodiment of the present invention, the reference device is an evolved node B (eNB).

According to the present invention, a method and apparatus for tracking a position using phase information in a wireless communication system can be provided.

In addition, it is also possible to provide a method for measuring a position by considering a range and phase relationship between signals in a wireless communication system.

Further, a method for performing position measurement based on PDOA in a wireless communication can also be provided.

It will be appreciated by persons skilled in the art that the effects that can be achieved through the present invention are not limited to what has been particularly described hereinabove and other advantages of the present invention will be more clearly understood from the following detailed description.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention.

FIG. 1 is a block diagram illustrating configurations of a base station 105 and user equipment 110 (or drone) in a wireless communication system 100.

FIG. 2 illustrates a structure of a radio frame used in a wireless communication system.

FIG. 3 illustrates structures of downlink/uplink (DL/UL) slots of a wireless communication system.

FIG. 4 illustrates a structure of a downlink (DL) subframe used in 3GPP LTE/LTE-A systems.

FIG. 5 illustrates a structure of an uplink (UL) subframe used in 3GPP LTE/LTE-A systems.

FIG. 6 illustrates a structure for transmitting a positioning reference signal (PRS).

FIG. 7 is a diagram illustrating a method for mapping a PRS to resource elements.

FIG. 8 is a diagram illustrating a positioning method based on direction of arrival (DOA).

FIG. 9 is a diagram illustrating a method performed by each reference device for measuring a position of a mobile device.

FIG. 10 is a diagram illustrating a method for transmitting reference signals at a mobile device and reference devices.

FIG. 11 is a diagram illustrating a method for measuring a position of a mobile device using a plurality of reference devices.

FIG. 12 is a diagram illustrating a procedure for measuring a position of a mobile device.

FIG. 13 is a flowchart illustrating a method for measuring a position of a mobile device.

### DETAILED DESCRIPTION OF THE INVENTION

Reference will now be made in detail to the preferred embodiments of the present invention, examples of which are illustrated in the accompanying drawings. In the following detailed description of the invention includes details to help the full understanding of the present invention. Yet, it is apparent to those skilled in the art that the present invention can be implemented without these details. For instance, although the following descriptions are made in detail on the assumption that a mobile communication system includes a 3rd Generation Partnership Project (3GPP) Long Term Evolution (LTE) system, the following descriptions are applicable to other random mobile communication systems in a manner of excluding unique features of the 3GPP LTE. Occasionally, to prevent the present invention from getting vaguer, structures and/or devices known to the public are skipped or can be represented as block diagrams centering on the core functions of the structures and/or devices. Wherever possible, the same reference numbers will be used throughout the drawings to refer to the same or like parts.

Besides, in the following description, assume that a terminal is a common name of such a mobile or fixed user stage device as a User Equipment (UE), a Mobile Station (MS), an Advanced Mobile Station (AMS) and the like. And, assume that a Base Station (BS) is a common name of such a random node of a network stage communicating with a terminal as a Node B (NB), an eNode B (eNB), an Access Point (AP) and the like. Although the present specification is described based on 3GPP LTE system or 3GPP LTE-A system, contents of the present invention may be applicable to various kinds of other communication systems.

In a mobile communication system, a UE is able to receive information in Downlink (DL) and is able to transmit information in Uplink (UL) as well. Information transmitted or received by the UE may include various kinds of data and control information. In accordance with types and usages of the information transmitted or received by the UE, various physical channels may exist.

The following descriptions are usable for various wireless access systems including Code Division Multiple Access (CDMA), Frequency Division Multiple Access (FDMA), Time Division Multiple Access (TDMA), Orthogonal Frequency Division Multiple Access (OFDMA), Single Carrier Frequency Division Multiple Access (SC-FDMA) and the like. CDMA can be implemented by such a radio technology as Universal Terrestrial Radio access (UTRA), CDMA 2000 and the like. TDMA can be implemented with such a radio technology as Global System for Mobile communications/General Packet Radio Service/Enhanced Data Rates for GSM Evolution (GSM/GPRS/EDGE). OFDMA can be implemented with such a radio technology as IEEE 802.11 (Wi-Fi), IEEE 802.16 (WiMAX), IEEE 802.20, E-UTRA (Evolved UTRA), etc. UTRA is a part of Universal Mobile Telecommunications System (UMTS). 3GPP LTE is a part of Evolved UMTS (E-UMTS) that uses E-UTRA. The 3GPP LTE employs OFDMA in DL and SC-FDMA in UL. And, LTE-A is an evolved version of 3GPP LTE.

Moreover, in the following description, specific terminologies are provided to help the understanding of the present invention. And, the use of the specific terminology can be modified into another form within the scope of the technical idea of the present invention.

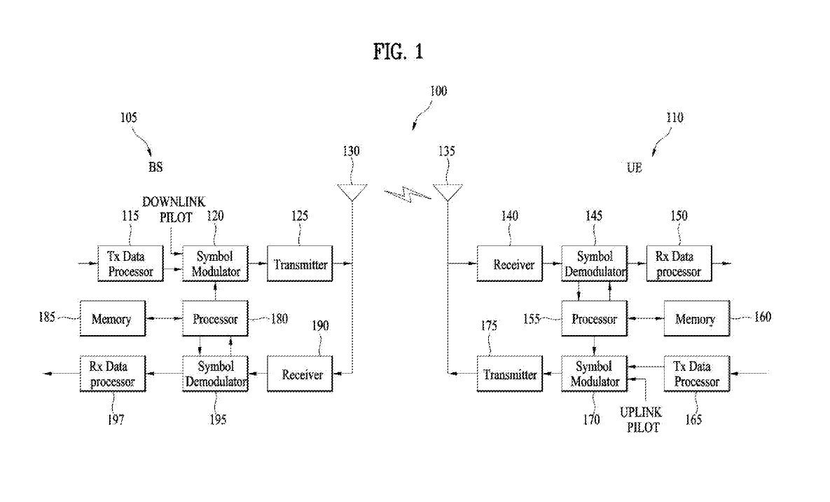

FIG. 1 is a block diagram for configurations of a BS 105 and a UE 110 in a wireless communication system 100.

Although one BS 105 and one UE 110 (D2D UE included) are shown in the drawing to schematically represent the wireless communication system 100, the wireless communication system 100 may include at least one BS and/or at least one UE.

Referring to FIG. 1, the BS 105 may include a Transmission (Tx) data processor 115, a symbol modulator 120, a transmitter 125, a transceiving antenna 130, a processor 180, a memory 185, a receiver 190, a symbol demodulator 195 and a received data processor 197. And, the UE 110 may include a Tx data processor 165, a symbol modulator 170, a transmitter 175, a transceiving antenna 135, a processor 155, a memory 160, a receiver 140, a symbol demodulator 155 and a received data processor 150. Although the BS/UE 105/110 includes one antenna 130/135 in the drawing, each of the BS 105 and the UE 110 includes a plurality of antennas. Therefore, each of the BS 105 and the UE 110 of the present invention supports a Multiple Input Multiple Output (MIMO) system. And, the BS 105 according to the present invention may support both Single User-MIMO (SU-MIMO) and Multi User-MIMO (MU-MIMO) systems.

In DL, the Tx data processor 115 receives traffic data, codes the received traffic data by formatting the received traffic data, interleaves the coded traffic data, modulates (or symbol maps) the interleaved data, and then provides modulated symbols (data symbols). The symbol modulator 120 provides a stream of symbols by receiving and processing the data symbols and pilot symbols.

The symbol modulator 120 multiplexes the data and pilot symbols together and then transmits the multiplexed symbols to the transmitter 125. In doing so, each of the transmitted symbols may include the data symbol, the pilot symbol or a signal value of zero. In each symbol duration, pilot symbols may be contiguously transmitted. In doing so, the pilot symbols may include symbols of Frequency Division Multiplexing (FDM), Orthogonal Frequency Division Multiplexing (OFDM), or Code Division Multiplexing (CDM).

The transmitter 125 receives the stream of the symbols, converts the received stream to at least one or more analog signals, additionally adjusts the analog signals (e.g., amplification, filtering, frequency upconverting), and then generates a downlink signal suitable for a transmission on a radio channel Subsequently, the downlink signal is transmitted to the user equipment via the antenna 130.

In the configuration of the UE 110, the receiving antenna 135 receives the downlink signal from the base station and then provides the received signal to the receiver 140. The receiver 140 adjusts the received signal (e.g., filtering, amplification and frequency downconverting), digitizes the adjusted signal, and then obtains samples. The symbol demodulator 145 demodulates the received pilot symbols and then provides them to the processor 155 for channel estimation.

The symbol demodulator 145 receives a frequency response estimated value for downlink from the processor 155, performs data demodulation on the received data symbols, obtains data symbol estimated values (i.e., estimated values of the transmitted data symbols), and then provides the data symbols estimated values to the received (Rx) data processor 150. The received data processor 150 reconstructs the transmitted traffic data by performing demodulation (i.e., symbol demapping, deinterleaving and decoding) on the data symbol estimated values.

The processing by the symbol demodulator 145 and the processing by the received data processor 150 are complementary to the processing by the symbol modulator 120 and the processing by the Tx data processor 115 in the BS 105, respectively.

In the UE 110 in UL, the Tx data processor 165 processes the traffic data and then provides data symbols. The symbol modulator 170 receives the data symbols, multiplexes the received data symbols, performs modulation on the multiplexed symbols, and then provides a stream of the symbols to the transmitter 175. The transmitter 175 receives the stream of the symbols, processes the received stream, and generates a UL signal. This UL signal is then transmitted to the BS 105 via the antenna 135.

In the BS 105, the UL signal is received from the UE 110 via the antenna 130. The receiver 190 processes the received UL signal and then obtains samples. Subsequently, the symbol demodulator 195 processes the samples and then provides pilot symbols received in UL and a data symbol estimated value. The received data processor 197 processes the data symbol estimated value and then reconstructs the traffic data transmitted from the UE 110.

The processor 155/180 of the user equipment/base station 110/105 directs operations (e.g., control, adjustment, management, etc.) of the user equipment/base station 110/105. The processor 155/180 may be connected to the memory unit 160/185 configured to store program codes and data. The memory 160/185 is connected to the processor 155/180 to store operating systems, applications and general files.

The processor 155/180 may be called one of a controller, a microcontroller, a microprocessor, a microcomputer and the like. And, the processor 155/180 may be implemented using hardware, firmware, software and/or any combinations thereof. In the implementation by hardware, the processor 155/180 may be provided with such a device configured to implement the present invention as Application Specific Integrated Circuits (ASICs), Digital Signal Processors (DSPs), Digital Signal Processing Devices (DSPDs), Programmable Logic Devices (PLDs), Field Programmable Gate Arrays (FPGAs), and the like.

Meanwhile, in case of implementing the embodiments of the present invention using firmware or software, the firmware or software may be configured to include modules, procedures, and/or functions for performing the above-explained functions or operations of the present invention. And, the firmware or software configured to implement the present invention is loaded in the processor 155/180 or saved in the memory 160/185 to be driven by the processor 155/180.

Layers of a radio protocol between a user equipment/base station and a wireless communication system (network) may be classified into 1st layer L1, 2nd layer L2 and 3rd layer L3 based on 3 lower layers of Open System Interconnection (OSI) model well known to communication systems. A physical layer belongs to the 1st layer and provides an information transfer service via a physical channel Radio Resource Control (RRC) layer belongs to the 3rd layer and provides control radio resourced between UE and network. A user equipment and a base station may be able to exchange RRC messages with each other through a wireless communication network and RRC layers.

In the present specification, although the processor 155/180 of the user equipment/base station performs an operation of processing signals and data except a function for the user equipment/base station 110/105 to receive or transmit a signal, for clarity, the processors 155 and 180 will not be mentioned in the following description specifically. In the following description, the processor 155/180 can be regarded as performing a series of operations such as a data processing and the like except a function of receiving or transmitting a signal without being specially mentioned.

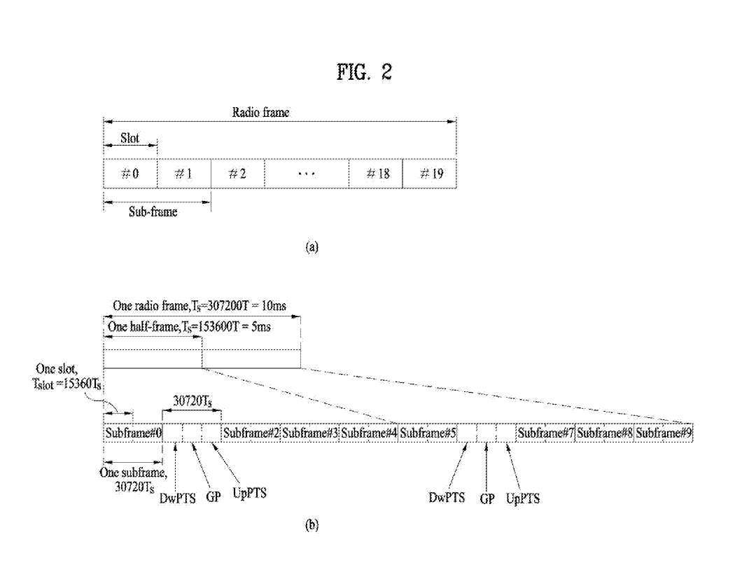

FIG. 2 is a diagram for an example of a radio frame structure used in a wireless communication system. Specifically, FIG. 2 (a) illustrates an exemplary structure of a radio frame which can be used for frequency division multiplexing (FDD) in 3GPP LTE/LTE-A system and FIG. 2 (b) illustrates an exemplary structure of a radio frame which can be used for time division multiplexing (TDD) in 3GPP LTE/LTE-A system.

Referring to FIG. 2, a 3GPP LTE/LTE-A radio frame is 10 ms (307,200 Ts) in duration. The radio frame is divided into 10 subframes of equal size. Subframe numbers may be assigned to the 10 subframes within one radio frame, respectively. Here, Ts denotes sampling time where Ts=1/(2048*15 kHz). Each subframe is 1 ms long and is further divided into two slots. 20 slots are sequentially numbered from 0 to 19 in one radio frame. Duration of each slot is 0.5 ms. A time interval in which one subframe is transmitted is defined as a transmission time interval (TTI). Time resources may be distinguished by a radio frame number (or radio frame index), a subframe number (or subframe index), a slot number (or slot index), and the like.

A radio frame may have different configurations according to duplex modes. In FDD mode for example, since DL transmission and UL transmission are discriminated according to frequency, a radio frame for a specific frequency band operating on a carrier frequency includes either DL subframes or UL subframes. In TDD mode, since DL transmission and UL transmission are discriminated according to time, a radio frame for a specific frequency band operating on a carrier frequency includes both DL subframes and UL subframes.

Table 1 shows an exemplary UL-DL configuration within a radio frame in TDD mode.

TABLE 1

| | Downlink- | | | | | | | | | | |
|---|---|---|---|---|---|---|---|---|---|---|---|
| | to-Uplink | | | | | | | | | | |
| | Switch- | | | | | | | | | | |
| DL-UL | point | Subframe number | | | | | | | | | |
| configuration | periodicity | 0 | 1 | 2 | 3 | 4 | 5 | 6 | 7 | 8 | 9 |
| 0 | 5 ms | D | S | U | U | U | D | S | U | U | U |
| 1 | 5 ms | D | S | U | U | D | D | S | U | U | D |
| 2 | 5 ms | D | S | U | D | D | D | S | U | D | D |
| 3 | 10 ms | D | S | U | U | U | D | D | D | D | D |
| 4 | 10 ms | D | S | U | U | D | D | D | D | D | D |
| 5 | 10 ms | D | S | U | D | D | D | D | D | D | D |
| 6 | 5 ms | D | S | U | U | U | D | S | U | U | D |

In Table 1, D denotes a DL subframe, U denotes a UL subframe, and S denotes a special subframe. The special subframe includes three fields, i.e. downlink pilot time slot (DwPTS), guard period (GP), and uplink pilot time slot (UpPTS). DwPTS is a time period reserved for DL transmission and UpPTS is a time period reserved for UL transmission. Table 2 shows an example of the special subframe configuration.

TABLE 2

| | Normal cyclic prefix in downlink | | | Extended cyclic prefix in downlink | | |
|---|---|---|---|---|---|---|
| | | UpPTS | | | UpPTS | |
| | | | Extended | | | Extended |
| Special | | Normal | cyclic | | Normal | cyclic |
| subframe | | cyclic prefix | prefix in | | cyclic prefix | prefix in |
| configuration | DwPTS | in uplink | uplink | DwPTS | in uplink | uplink |
| 0 | 6592 · Tₛ | 2192 · Tₛ | 2560 · Tₛ | 7680 · Tₛ | 2192 · Tₛ | 2560 · Tₛ |
| 1 | 19760 · Tₛ | | | 20480 · Tₛ | | |
| 2 | 21952 · Tₛ | | | 23040 · Tₛ | | |
| 3 | 24144 · Tₛ | | | 25600 · Tₛ | | |
| 4 | 26336 · Tₛ | | | 7680 · Tₛ | 4384 · Tₛ | 5120 · Tₛ |
| 5 | 6592 · Tₛ | 4384 · Tₛ | 5120 · Tₛ | 20480 · Tₛ | | |
| 6 | 19760 · Tₛ | | | 23040 · Tₛ | | |
| 7 | 21952 · Tₛ | | | 12800 · Tₛ | | |
| 8 | 24144 · Tₛ | | | — | — | — |
| 9 | 13168 · Tₛ | | | — | — | — |

FIG. 2 illustrates the structure of a DL/UL slot structure in a wireless communication system. In particular, FIG. 2 illustrates the structure of a resource grid of a 3GPP LTE/LTE-A system. One resource grid is defined per antenna port

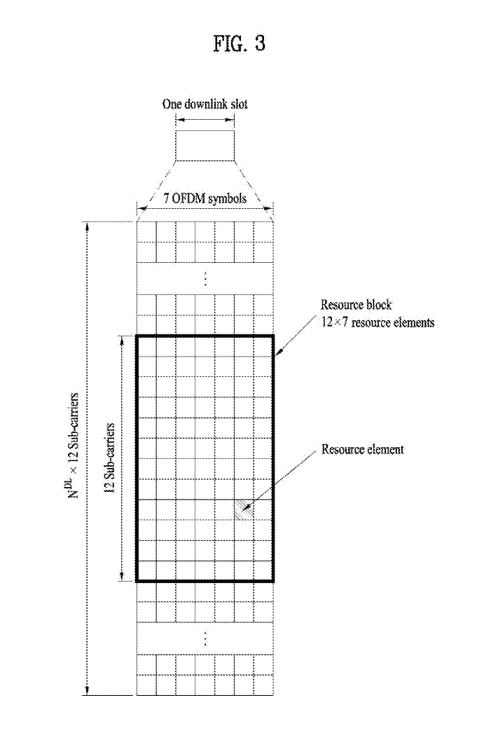

Referring to FIG. 3, a slot includes a plurality of orthogonal frequency division multiplexing (OFDM) symbols in the time domain and includes a plurality of resource blocks (RBs) in the frequency domain. The OFDM symbol may refer to one symbol duration. Referring to FIG. 3, a signal transmitted in each slot may be expressed by a resource grid including N^{DL/UL}_{RB}*N^{RB}_{sc} subcarriers and N^{DL/UL}_{symb} OFDM symbols. N^{DL}_{RB} denotes the number of RBs in a DL slot and N^{UL}_{RB} denotes the number of RBs in a UL slot. N^{DL}_{RB} and N^{UL}_{RB} depend on a DL transmission bandwidth and a UL transmission bandwidth, respectively. N^{DL}_{symb} denotes the number of OFDM symbols in a DL slot, N^{UL}_{symb} denotes the number of OFDM symbols in a UL slot, and N^{RB}_{sc} denotes the number of subcarriers configuring one RB.

An OFDM symbol may be referred to as an OFDM symbol, a single carrier frequency division multiplexing (SC-FDM) symbol, etc. according to multiple access schemes. The number of OFDM symbols included in one slot may be varied according to channel bandwidths and CP lengths. For example, in a normal cyclic prefix (CP) case, one slot includes 7 OFDM symbols. In an extended CP case, one slot includes 6 OFDM symbols. Although one slot of a subframe including 7 OFDM symbols is shown in FIG. 3 for convenience of description, embodiments of the present invention are similarly applicable to subframes having a different number of OFDM symbols. Referring to FIG. 3, each OFDM symbol includes N^{DL/UL}_{RB}*N^{RB}_{sc} subcarriers in the frequency domain. The type of the subcarrier may be divided into a data subcarrier for data transmission, a reference signal (RS) subcarrier for RS transmission, and a null subcarrier for a guard band and a DC component. The null subcarrier for the DC component is unused and is mapped to a carrier frequency f₀ in a process of generating an OFDM signal or in a frequency up-conversion process. The carrier frequency is also called a center frequency.

One RB is defined as N^{DL/UL}_{symb} (e.g. 7) consecutive OFDM symbols in the time domain and as N^{RB}_{sc} (e.g. 12) consecutive subcarriers in the frequency domain. For reference, a resource composed of one OFDM symbol and one subcarrier is referred to a resource element (RE) or tone. Accordingly, one RB includes N^{DL/UL}_{symb}*N^{RB}_{sc} REs. Each RE within a resource grid may be uniquely defined by an index pair (k, l) within one slot. k is an index ranging from 0 to N^{DL/UL}_{RB}*N^{RB}_{sc}−1 in the frequency domain, and l is an index ranging from 0 to N^{DL/UL}_{symb}1−1 in the time domain.

In one subframe, two RBs each located in two slots of the subframe while occupying the same N^{RB}_{sc} consecutive subcarriers are referred to as a physical resource block (PRB) pair. Two RBs configuring a PRB pair have the same PRB number (or the same PRB index). A VRB corresponds to a logical resource allocation unit which is introduced to allocate a resource. The VRB has a size identical to a size of a PRB. The VRB is classified into a localized type VRB and a distributed type VRB according to a scheme of mapping the VRB to a PRB. Since VRBs of the localized type are directly mapped to PRBs, a VRB number (or VRB index) directly corresponds to a PRB number. In particular, it becomes n_{PRB}=n_{VRB}. Numbers ranging from 0 to N^{DL}_{PRB}−1 are assigned to the VRBs of the localized type and N^{DL}_{VRB}=N^{DL}_{RB}. Hence, according to the localized mapping scheme, a VRB having the same VRB number is mapped to a PRB of the same PRB number in a first slot and a second slot. On the contrary, a VRB of the distributed type is mapped to a PRB by passing through interleaving. Hence, a VRB of the distributed type including the same VRB number can be mapped to PRBs of a different number in a first slot and a second slot. Two PRBs each of which is located at each slot of a subframe and having the same VRB number are referred to as a VRB pair.

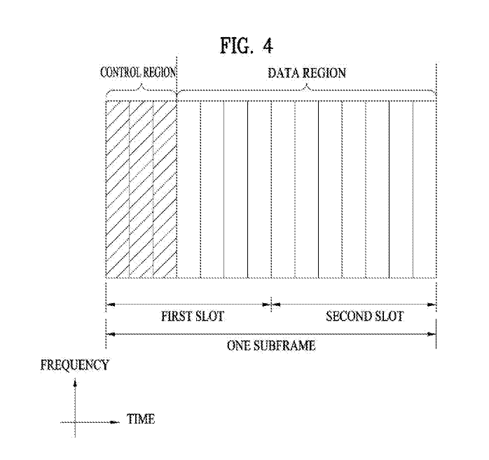

FIG. 4 illustrates a structure of a DL subframe used in 3GPP LTE/LTE-A system.

Referring to FIG. 4, a DL subframe is divided into a control region and a data region in the time domain. Referring to FIG. 4, a maximum of 3 (or 4) OFDM symbols located in a front part of a first slot of a subframe corresponds to the control region. Hereinafter, a resource region for PDCCH transmission in a DL subframe is referred to as a PDCCH region. OFDM symbols other than the OFDM symbol(s) used in the control region correspond to the data region to which a physical downlink shared channel (PDSCH) is allocated. Hereinafter, a resource region available for PDSCH transmission in the DL subframe is referred to as a PDSCH region. Examples of a DL control channel used in 3GPP LTE include a physical control format indicator channel (PCFICH), a physical downlink control channel (PDCCH), a physical hybrid ARQ indicator channel (PHICH), etc. The PCFICH is transmitted in the first OFDM symbol of a subframe and carries information about the number of OFDM symbols available for transmission of a control channel within a subframe. The PCFICH carries a HARQ (Hybrid Automatic Repeat Request) ACK/NACK (acknowledgment/negative-acknowledgment) signal in response to UL transmission.

The control information transmitted through the PDCCH will be referred to as downlink control information (DCI). The DCI includes resource allocation information for a UE or UE group and other control information. For example, the DCI includes transmit format and resource allocation information of a downlink shared channel (DL-SCH), transmit format and resource allocation information of an uplink shared channel (UL-SCH), paging information of a paging channel (PCH), system information on a DL-SCH, resource allocation information of a upper layer control message such as a random access response transmitted on PDSCH, a transmit power control command for individual UEs belonging to a UE group, a transmit power control command, activation indication information of VoIP (Voice over IP), a DAI (downlink assignment index), and the like. Transmit format and resource allocation information of a downlink shared channel (DL-SCH) are referred to as DL scheduling information or DL grant. Transmit format and resource allocation information of an uplink shared channel (UL-SCH) are referred to as UL scheduling information or UL grant. The size and usage of the DCI carried by one PDCCH are varied depending on DCI formats. The size of the DCI may be varied depending on a coding rate. In the current 3GPP LTE system, various formats are defined, wherein formats 0 and 4 are defined for a UL, and formats 1, 1A, 1B, 1C, 1D, 2, 2A, 2B, 2C, 3 and 3A are defined for a DL. Combination selected from control information such as a hopping flag, RB allocation, modulation coding scheme (MCS), redundancy version (RV), new data indicator (NDI), transmit power control (TPC), cyclic shift demodulation reference signal (DM RS), UL index, channel quality information (CQI) request, DL assignment index, HARQ process number, transmitted precoding matrix indicator (TPMI), precoding matrix indicator (PMI) information is transmitted to the UE as the DCI.

In general, a DCI format capable of being transmitted to a UE varies depending on a transmission mode (TM) set to the UE. In other word, if a UE is configured by a specific transmission mode, it may be able to use a prescribed DCI format(s) corresponding to the specific transmission mode only rather than all DCI formats.

A PDCCH is formed by aggregating one or more consecutive Control Channel Elements (CCEs). A CCE is a logical allocation unit used to provide a PDCCH at a coding rate based on the state of a radio channel. A CCE corresponds to a plurality of resource element groups (REGs). For example, one CCE corresponds to 9 REGs and one REG corresponds to 4 REs. 3GPP LTE defines a CCE set where PDCCH is able to be positioned for each of the user equipments. The CCE set for which a user equipment is able to search its own PDCCH is called a PDCCH search space, simply a search space (SS). An individual resource to which PDCCH is able to be transmitted thereto within the SS is called a PDCCH candidate. A set of PDCCH candidates to be monitored by a UE is defined as a search space. In 3GPP LTE/LTE-A system, a search space for each DCI format may have a different size and a dedicated search space and a common search space are separately defined. The dedicated search space corresponds to a UE-specific search space and may be individually set for each of user equipments. The common search space is configured for a plurality of UEs. Aggregation levels for defining the search space are shown in the following.

TABLE 3

| Search Space S_{K}^{(L)} | | | Number of PDCCH |
|---|---|---|---|
| Type | Aggregation Level L | Size [in CCEs] | candidates M^{(L)} |
| UE- | 1 | 6 | 6 |
| specific | 2 | 12 | 6 |
| | 4 | 8 | 2 |
| | 8 | 16 | 2 |
| Common | 4 | 16 | 4 |
| | 8 | 16 | 2 |

One PDCCH candidate corresponds to 1, 2, 4, or 8 CCEs according to a CCE aggregation level. An eNB transmits actual PDCCH (DCI) in a random PDCCH candidate belonging to a search space and a UE monitors the search space to find out PDCCH (DCI). In this case, the verb ‘monitor’ means that the UE attempts to decode each of the PDCCH candidates belonging to the search space in accordance with PDCCH formats monitored by the UE. The UE monitors a plurality of PDCCHs and may be able to detect PDCCH of the UE. Basically, since the UE is unable to know a position from which the PDCCH of the UE is transmitted, the UE attempts to decode all PDCCHs of a corresponding DCI format in every subframe until PDCCH including an identifier of the UE is detected. This process is referred to as blind detection (blind decoding (BD)).

An eNB can transmit data for a UE or a UE group via a data region. The data transmitted via the data region is referred to as a user data. In order to transmit the user data, PDSCH (physical downlink shared channel) can be assigned to the data region. PCH (paging channel) and DL-SCH (downlink-shared channel) are transmitted via the PDSCH. A UE decodes control information transmitted on the PDCCH to read the data transmitted via the PDSCH. Information indicating a UE or a UE group to which the data of the PDSCH is transmitted and information indicating a method for the UE or the UE group to receive and decode the PDSCH data are transmitted in a manner of being included in the PDCCH. For example, it is assumed that a specific PDCCH is CRC-masked with a Radio Network Temporary Identity (RNTI) “A”, and information about data transmitted using a radio resource (e.g., frequency location) “B” and transmission format information (e.g., transmission block size, modulation scheme, coding information, or the like) “C” is transmitted via a specific DL subframe. In this case, a UE monitors a PDCCH using its own RNTI information, and if one or more UEs having “A” RNTI are present, the UEs receive the PDCCH and receive the PDSCH indicated by “B” and “C” through the information about the received PDCCH.

In order for a UE to demodulate a signal received from an eNB, it is necessary to have a reference signal (RS) to be compared with a data signal. The reference signal corresponds to a signal of a predetermined specific waveform transmitted to the UE by the eNB or to the eNB by the UE and is referred to as a pilot signal as well. Reference signals are classified into a cell-specific RS commonly used by all UEs in a cell and a demodulation RS (DM RS) dedicated to a specific UE. A DM RS transmitted by an eNB to demodulate downlink data of a specific UE is referred to as a UE-specific RS. In DL, it may transmit a DM RS and a CRS together or transmit either the DM RS or the CRS only. In this case, if the DM RS is transmitted only in DL without the CRS, since the DM RS, which is transmitted by applying the same precoder with data, is used for demodulation purpose only, it is necessary to separately provide an RS for measuring a channel. For example, in 3GPP LTE (−A), an additional RS for measuring a channel, i.e., a CSI-RS, is transmitted to a UE to make the UE measure channel state information. Unlike a CRS transmitted in every subframe, the CSI-RS is transmitted with a prescribed transmission period consisting of a plurality of subframes based on a fact that a channel state is not considerably changed over time.

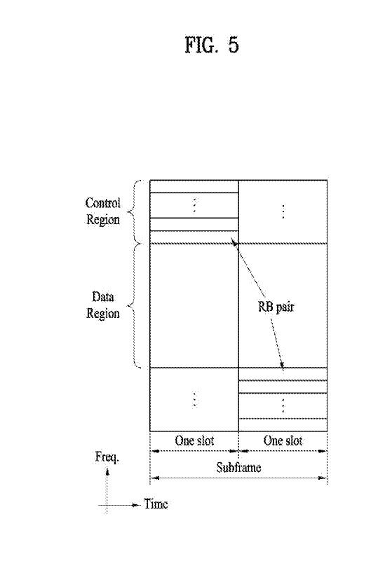

FIG. 5 is a diagram for an example of an uplink (UL) subframe structure used in 3GPP LTE/LTE-A system.

Referring to FIG. 5, an UL subframe can be divided into a control region and a data region in frequency domain. At least one PUCCH (physical uplink control channel) can be assigned to the control region to transmit uplink control information (hereinafter abbreviated UCI). At least one PUSCH (physical uplink shared channel) can be assigned to the data region to transmit user data.

In an UL subframe, subcarriers far from a DC (direct current) subcarrier are utilized as a control region. In other word, subcarriers positioned at both ends of an UL transmission bandwidth are assigned to transmit UCI. The DC subcarrier is a remaining component not used for transmitting a signal and mapped to a carrier frequency f₀ in a frequency up converting process. PUCCH for one UE is assigned to an RB pair in one subframe. RBs belonging to the RB pair occupy a subcarrier different from each other in two slots, respectively. This sort of PUCCH can be represented in a manner that the RB pair allocated to the PUCCH is frequency hopped on a slot boundary. Yet, if a frequency hopping is not applied, the RB pair occupies an identical subcarrier.

PUCCH can be used for transmitting control information described in the following.

SR (scheduling request): Information used for requesting uplink UL-SCH resource. OOK (on-off keying) scheme is used to transmit the SR.

HARQ ACK/NACK: Response signal for PDCCH and/or a DL data packet (e.g., codeword) on PDSCH. This information indicates whether or not PDCCH or PDSCH is successfully received. HARQ-ACK 1 bit is transmitted in response to a single DL codeword. HARQ-ACK 2 bits are transmitted in response to two DL codewords. HARQ-ACK response includes a positive ACK (simple, ACK), a negative ACK (hereinafter, NACK), DTX (discontinuous transmission), or NACK/DTX. In this case, the term HARQ-ACK is used in a manner of being mixed with HARQ ACK/NACK, ACK/NACK.

CSI (channel state information): Feedback information on a DL channel. MIMO (multiple input multiple output)-related feedback information includes an RI (rank indicator) and a PMI (precoding matrix indicator).

An amount of control information (UCI) capable of being transmitted by a UE in a subframe depends on the number of SC-FDMAs available for transmitting control information. The SC-FDMAs available for transmitting the control information correspond to the remaining SC-FDMA symbols except SC-FDMA symbols used for transmitting a reference signal in a subframe. In case of a subframe to which an SRS (sounding reference signal) is set, the last SC-FDMA symbol of the subframe is also excluded. A reference signal is used for coherent detection of PUCCH. PUCCH supports various formats depending on transmitted information.

Table 4 in the following shows a mapping relation between a PUCCH format and UCI in LTE/LTE-A system.

TABLE 4

| PUCCH | Modulation | Number of bits | | |
|---|---|---|---|---|
| format | scheme | per subframe | Usage | Etc. |
| 1 | N/A | N/A | SR (Scheduling Request) | |
| | | (exist or absent) | | |
| 1a | BPSK | 1 | ACK/NACK or R + | One codeword |
| | | | ACK/NACK | |
| 1b | QPSK | 2 | ACK/NACK or | Two codeword |
| | | | SR + ACK/NACK | |
| 2 | QPSK | 20 | CQI/PMI/RI | Joint coding |
| | | | | ACK/NACK |
| | | | | (extended CP) |
| 2a | QPSK + BPSK | 21 | CQI/PMI/RI + ACK/NACK | Normal CP only |
| 2b | QPSK + QPSK | 22 | CQI/PMI/RI + ACK/NACK | Normal CP only |
| 3 | QPSK | 48 | ACK/NACK or | |
| | | | SR + ACK/NACK or | |
| | | | CQI/PMI/RI + ACK/NACK | |

Referring to Table 4, a PUCCH format 1 is mainly used for transmitting ACK/NACK and a PUCCH format 2 is mainly used for transmitting channel state information (CSI) such as CQI/PMI/RI, and a PUCCH format 3 is mainly used for transmitting ACK/NACK information.

In general, in order for a network to obtain location information of a UE, various methods are used in a cellular communication system. As a representative method, a UE receives PRS (positioning reference signal) transmission-related configuration information of a base station from a higher layer signal and measures PRSs transmitted by cells adjacent to the UE to calculate location-related information of the UE using a positioning scheme such as OTDOA (observed time difference of arrival) and forwards the calculated information to the network. Besides, an assisted global navigation satellite system (A-GNSS) positioning scheme, enhanced cell-ID (E-CID) techniques, uplink time difference of arrival (UTDOA), and the like exist. The abovementioned positioning schemes can be utilized for various location-based services (e.g., advertising, location tracking, emergency communication means, etc.).

In LTE system, LPP (LTE positioning protocol) is defined to support the OTDOA scheme. According to the LPP, OTDOA-ProvideAssistanceData having a configuration described in the following is transmitted to a UE as an IE (information element).

```
TABLE 5
        ASN1START
    OTDOA-ProvideAssistanceData ::= SEQUENCE {
```

| | |
|---|---|
| otdoa-ReferenceCellInfo | OTDOA-ReferenceCellInfo |

OPTIONAL, -- Need ON

| | |
|---|---|
| otdoa-NeighbourCellInfo | OTDOA- |

```
    NeighbourCellInfoList
              OPTIONAL, -- Need ON
    otdoa-Error
              OTDOA-Error
                OPTIONAL,
        Need ON
    ...
    }
-- ASN1STOP
```

In this case, OTDOA-ReferenceCellInfo corresponds to a reference cell for measuring RSTD and can be configured as follows.

TABLE 6
ASN1START
OTDOA-ReferenceCellInfo ::= SEQUENCE {

| | |
|---|---|
| physCellId | INTEGER (0..503), |

| | |
|---|---|
| cellGlobalId | ECGI |

OPTIONAL, -- Need ON

| | |
|---|---|
| earfcnRef | ARFCN-ValueEUTRA |

OPTIONAL, -- Cond NotSameAsServ0

| | |
|---|---|
| antennaPortConfig | ENUMERATED {ports1-or-2, |

```
      ports4, ... }
      OPTIONAL, -- Cond NotSameAsServ1
```

| | |
|---|---|
| cpLength | ENUMERATED { normal, |
| extended, ... }, | |

| | |
|---|---|
| prsInfo | PRS-Info |
| OPTIONAL, -- Cond PRS..., | |

| | |
|---|---|
| [[ earfcnRef-v9a0 | ARFCN-ValueEUTRA-v9a0 |

```
      OPTIONAL -- Cond NotSameAsServ2]]
      }
-- ASN1STOP
```

In this case, conditional presences are shown in the following.

TABLE 7

| Conditional | |
|---|---|
| presence | description |
| NotSameAsServ0 | This field is absent if earfcnRef-v9a0 is present. |
| | Otherwise, the field is mandatory present if the |
| | EARFCN of the OTDOA assistance data reference cell |
| | is not the same as the EARFCN of the target devices's |
| | current primary cell. |
| NotSameAsServ1 | The field is mandatory present if the antenna port |
| | configuration of the OTDOA assistance data reference |
| | cell is not the same as the antenna port configuration |
| | of the target devices's current primary cell. |
| NotSameAsServ2 | The field is absent if earfcnRef is present. Otherwise, |
| | the field is mandatory present if the EARFCN of the |
| | OTDOA assistance data reference cell is not the same |
| | as the EARFCN of the target devices's current primary |
| | cell. |
| PRS | The field is mandatory present if positioning reference |
| | signals are available in the assistance data reference |
| | cell; otherwise it is not present. |

Each individual field of the OTDOA-ReferenceCellInfo is described in the following.

TABLE 8
OTDOA-ReferenceCellInfo field description

physCellId
This field specifies the physical cell identity of the assistance data
reference cell.
cellGlobalId
This field specifies the ECGI, the globally unique identity of a cell in
E-UTRA, of the assistance data reference cell. The server should include
this field if it considers that it is needed to resolve ambiguity in the cell
indicated by physCellId.
earfcnRef
This field specifies the EARFCN of the assistance data reference cell.
antennaPortConfig
This field specifies whether 1 (or 2) antenna port(s) or 4 antenna ports for
cell specific reference signals (CRS) are used in the assistance data
reference cell.
cpLength
This field specifies the cyclic prefix length of the assistance data reference
cell PRS if the prsInfo field is present, otherwise this field specifies the
cyclic prefix length of the assistance data reference cell CRS.
prsInfo
This field specifies the PRS configuration of the assistance data reference
cell.

Meanwhile, OTDOA-NeighbourCellInfo corresponds to cells (e.g., an eNB or a TP) becoming a target of RSTD measurement and can include information on maximum 24 neighbor cells according to each frequency layer for maximum 3 frequency layers. In particular, it may be able to inform a UE of information on 72 (3*24) cells in total.

TABLE 9
ASN1START
OTDOA-NeighbourCellInfoList ::= SEQUENCE
(SIZE (1..maxFreqLayers)) OF OTDOA-NeighbourFreqInfo
OTDOA-NeighbourFreqInfo ::= SEQUENCE (SIZE (1..24)) OF OTDOA-
NeighbourCellInfoElement
OTDOA-NeighbourCellInfoElement ::= SEQUENCE {

| physCellI | INTEGER |
|---|---|
| (0..503), | |

| | |
|---|---|
| cellGlobalId | ECGI |
| OPTIONAL, -- Need ON | |

| | |
|---|---|
| earfcn | ARFCN- |

alueEUTRA OPTIONAL, -- Cond NotSameAsRef0

| | |
|---|---|
| cpLength | ENUMERATED |

{normal, extended, ...}
OPTIONAL, -- Cond NotSameAsRef1

| | |
|---|---|
| rsInfo | PRS-Info |
| OPTIONAL, -- Cond NotSameAsRef2 | |

| | |
|---|---|
| antennaPortConfig | ENUMERATED {ports-1-or- |

2, ports-4, ...}
OPTIONAL, -- Cond NotsameAsRef3

| | |
|---|---|
| slotNumberOffset | INTEGER (0..19) |

OPTIONAL, -- Cond NotSameAsRef4

| | |
|---|---|
| prs-SubframeOffset | INTEGER (0..1279) |

OPTIONAL, -- Cond InterFreq

| | |
|---|---|
| expectedRSTD | INTEGER (0..16383), |

| | |
|---|---|
| expectedRSTD-Uncertainty | INTEGER (0..1023), |
| ..., | |
| [[ earfcn-v9a0 | ARFCN-ValueEUTRA-v9a0 |

OPTIONAL -- Cond NotSameAsRef5]]
}
maxFreqLayers INTEGER ::= 3
-- ASN1STOP

In this case, conditional presences are shown in the following.

TABLE 10

| Conditional presence | Description |
|---|---|
| NotSameAsRef0 | The field is absent if earfcn-v9a0 is present. If earfcn-v9a0 is |
| | not present, the field is mandatory present if the EARFCN is |
| | not the same as for the assistance data reference cell; otherwise |
| | it is not present. |
| NotSameAsRef1 | The field is mandatory present if the cyclic prefix length is not |
| | the same as for the assistance data reference cell; otherwise it is |
| | not present. |
| NotSameAsRef2 | The field is mandatory present if the PRS configuration is not |
| | the same as for the assistance data reference cell; otherwise it is |
| | not present. |
| NotSameAsRef3 | The field is mandatory present if the antenna port configuration |
| | is not the same as for the assistance data reference cell; |
| | otherwise it is not present. |
| NotSameAsRef4 | The field is mandatory present if the slot timing is not the same |
| | as for the assistance data reference cell; otherwise it is not |
| | present. |
| NotSameAsRef5 | The field is absent if earfcn is present. If earfcn is not present, |
| | the field is mandatory present if the EARFCN is not the same |
| | as for the assistance data reference cell; otherwise it is not |
| | present. |
| InterFreq | The field is optionally present, need OP, if the EARFCN is not |
| | the same as for the assistance data reference cell; otherwise it is |
| | not present. |

Each individual field of the OTDOA-NeighbourCellInfoList is described in the following.

TABLE 11
OTDOA-NeighbourCellInfoList field description

physCellId
This field specifies the physical cell identity of the assistance data reference cell.
cellGlobalId
This field specifies the ECGI, the globally unique identity of a cell in E-UTRA, of the
assistance data reference cell. The server should include this field if it considers that it is
needed to resolve ambiguity in the cell indicated by physCellId.
earfcnRef
This field specifies the EARFCN of the assistance data reference cell.
antennaPortConfig
This field specifies whether 1 (or 2) antenna port(s) or 4 antenna ports for cell specific
reference signals (CRS) are used in the assistance data reference cell.
cpLength
This field specifies the cyclic prefix length of the neigbour cell PRS if PRS are present in this
neighbour cell, otherwise this field specifies the cyclic prefix length of CRS in this neighbour
cell.
prsInfo
This field specifies the PRS configuration of the neighbour cell.
When the EARFCN of the neighbour cell is the same as for the assistance data reference cell,
the target device may assume that each PRS positioning occasion in the neighbour cell at
least partially overlaps with a PRS positioning occasion in the assistance data reference cell
where the maximum offset between the transmitted PRS positioning occasions may be
assumed to not exceed half a subframe.
When the EARFCN of the neighbour cell is the same as for the assistance data reference cell,
the target device may assume that this cell has the same PRS periodicity (Tprs) as the
assistance data reference cell.

In this case, PRS-Info corresponding to an IE, which is included in the OTDOA-ReferenceCellInfo and the OTDOA-NeighbourCellInfo, includes PRS information. Specifically, the PRS-Info is configured as follows while including PRS Bandwidth, PRS Configuration Index (IPRS), Number of Consecutive Downlink Subframes, and PRS Muting Information.

TABLE 12

| | |
|---|---|
| PRS-Info ::= SEQUENCE { | |
| prs-Bandwidth | ENUMERATED { n6, n15, n25, n50, |
| n75, n100, ... }, | |

| | |
|---|---|
| prs-ConfigurationIndex | INTEGER (0..4095), |

| | |
|---|---|
| numDL-Frames | ENUMERATED {sf-1, sf-2, sf-4, sf- |
| 6, ...}, | |
| ..., | |

| | |
|---|---|
| prs-MutingInfo-r9 | CHOICE { |

| | |
|---|---|
| po2-r9 | BIT STRING |
| (SIZE(2)), | |
| po4-r9 | BIT STRING |
| (SIZE(4)), | |
| po8-r9 | BIT STRING |
| (SIZE(8)), | |
| po16-r9 | BIT STRING |
| (SIZE(16)), | |
| ... | |
| } | |

```
            OPTIONAL -- Need OP
  }-- ASN1STOP
```

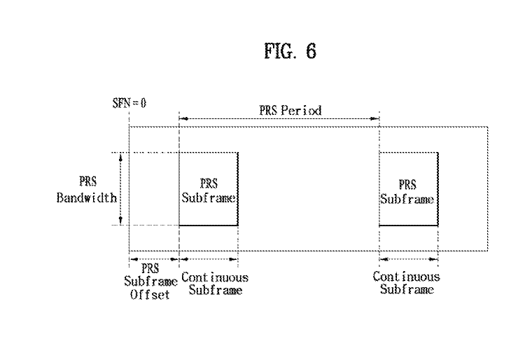

FIG. 6 is a diagram for a PRS transmission structure according to the parameters. In this case, PRS periodicity and PRS subframe offset are determined according to a value of PRS configuration index (IPRS) and a corresponding relation is shown in the following table.

TABLE 13

| PRS | PRS | PRS Subframe |
|---|---|---|
| Configuration Index(I_{PRS}) | Periodicity(subframes) | Offset(subframes) |
| 0-159 | 160 | I_{PRS} |
| 160-479 | 320 | I_{PRS}-160 |
| 480-1119 | 640 | I_{PRS}-480 |
| 1120-23399 | 1280 | I_{PRS}-1120 |

[PRS (Positioning Reference Signal)]

A PRS has a transmission occasion, that is, a positioning occasion at an interval of 160, 320, 640, or 1280 ms, and it may be transmitted in N consecutive DL subframes at the positioning occasion where N may be 1, 2, 4, or 6. Although the PRS may be substantially transmitted at the positioning occasion, it may be muted for inter-cell interference control cooperation. Information on PRS muting is signaled to a UE through prs-MutingInfo. Unlike a system bandwidth of a serving eNB, a PRB transmission bandwidth may be independently configured and the PRS is transmitted in a frequency bandwidth of 6, 15, 25, 50, 75, or 100 resource blocks (RBs). A transmission sequence for the PRS is generated by initializing a pseudo-random sequence generator for every OFDM symbol using a function of a slot index, an OFDM symbol index, a cyclic prefix (CP) type, and a cell ID. The generated transmission sequences for the PRS can be differently mapped to resource elements (REs) based on whether a normal CP or extended CP is used. A position of the mapped RE may be shifted on the frequency axis, and in this case, a shift value is determined by a cell ID.

For PRS measurement, a UE receives configuration information on a list of PRSs that the UE should search for from a positioning server of the network. The corresponding information includes PRS configuration information of a reference cell and PRS configuration information of neighboring cells. Configuration information for each PRS includes a generation period of the positioning occasion and offset thereof, the number of consecutive DL subframes included in one positioning occasion, a cell ID used in generating a PRS sequence, a CP type, the number of CRS antenna ports considered in PRS mapping, etc. In addition, the PRS configuration information of neighboring cells includes slot offsets and subframe offsets of the neighbor cells and reference cell, expected RSTD, and a degree of uncertainty of the expected RSTD. Thus, the PRS configuration information of neighboring cells supports the UE to determine when and which time window the UE should search for corresponding PRSs to detect PRSs transmitted from the neighboring cells.

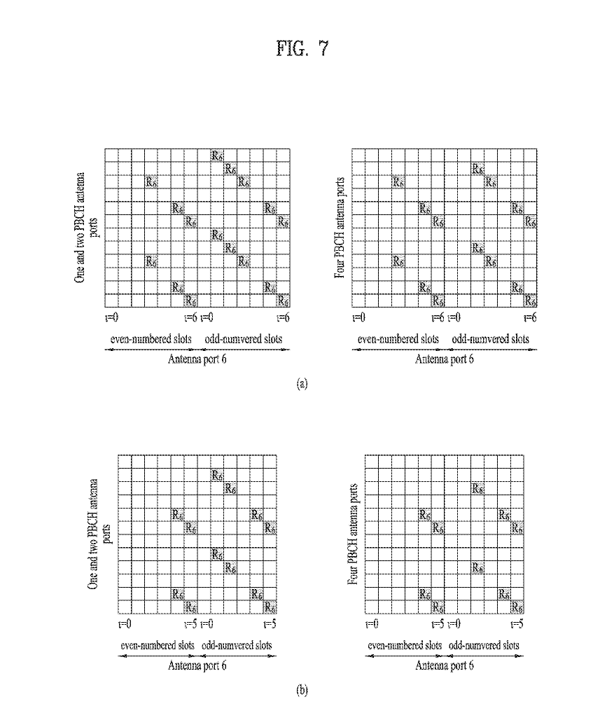

For example, FIG. 7 is a diagram illustrating mapping of a PRS to resource elements. A transmission sequence for the PRS is generated by initializing a pseudo-random sequence generator for every OFDM symbol using a function of a slot index, an OFDM symbol index, a cyclic prefix (CP) type, and a physical cell ID. When a normal CP is used, the generated sequences can be mapped as shown in FIG. 7(a). When an extended CP is sued, the generated sequences can be mapped as shown in FIG. 7(b). A position of the mapped RE may be shifted on the frequency axis, and a shift value is determined by the physical cell ID. In this case, for example, the positions of REs for PRS transmission shown in FIGS. 7 (a) and (b) may be calculated on the assumption that the frequency shift is 0.

Meanwhile, the aforementioned RSTD may mean a relative timing difference between adjacent or neighboring cell j and reference cell i. That is, the RSTD can be expressed as T_{subframeRxj}−T_{subframeRxi}, where T_{subframeRxj} indicates a time when the UE receives the start of a specific subframe from the adjacent cell j, and T_{subframeRxi} indicates a time when the UE receives the start of a subframe corresponding to the specific subframe from the reference cell i, which is closest in time to the specific subframe received from the adjacent cell j. The reference point for the observed subframe time difference could be an antenna connector of the UE.

As described above, the network can obtain position information of the UE in the wireless communication system using various methods.

As another example, the UE's position can be measured using phase information in the wireless communication system. For instance, a distance may be primarily influenced by hardware components but less influenced by phase differences. In a single antenna system, Equation 1 below may be used to calculate a distance. In Equation 1, d is a distance, λ is a wavelength, Ø is a phase difference between transmitted and received signals, and n is a positive integer.

$$d = \frac{λ}{2} ( \frac{∅}{2 π} + n ) \qquad [ Equation 1 ]$$

In Equation 1, the distance d may be determined according to λ/2 irrespective of the phase change, Ø. In detail, Ø can be determined according to an internal phase Øᵢₙₜ and a propagation phase Øₚᵣₒₚ as shown in Equation 2 below. However, in Equation 2, Øᵢₙₜ is an initial value and cannot be calculated. Thus, the distance d can be measured based on λ/2 regardless of the phase change in Equation 1.

Ø=Øᵢₙₜ+Øprop [Equation 2]

However, for example, when two different frequencies are used, the above-described Øᵢₙₜ factor can be eliminated in the calculation. Specifically, if the different frequencies have the same Øᵢₙₜ value, it can be eliminated in the calculation, and thus position measurement can be performed using phase information. In this case, the PDOA scheme may be used to measure a distance using different frequencies. According to the PDOA scheme, a position is measured using a phase difference at difference frequencies with respect to received signal.

In detail, when the position measurement is performed based on the PDOA scheme, two basic frequencies may be used. For example, a RFID reader can transmit two continuous wave signals at frequencies f₁ and f₂. In this case, a phase at frequency i can be expressed as shown in Equation 3 below irrespective of modulation and noise of the RFID. In this case, i may have a value of 1 or 2, and c indicates the propagation velocity or the speed of light, i.e., c=3×10⁸.

Øᵢ=4πfᵢd/c, [Equation 3]

The value of d can be calculated according to Equation 3. That is, the phase difference is present as many as the frequency difference, and this can be expressed as shown in Equation 4. In this case, the conditions of 0<Øᵢ<2π and 0<ΔØ=Ø₂−Ø₁<2π can be satisfied.

$$\hat{d} = \frac{c Δ∅}{4 π ( {f}_{2} - {f}_{1} )} + \frac{cm}{2 ( {f}_{2} - {f}_{1} )} \qquad [ Equation 4 ]$$

For example, in Equation 4, the second term may denote range ambiguity due to phase wrapping. The maximum value of an ambiguous distance may be expressed as dₘₐₓ=c/2|f₂−f₁|. In other words, as the frequency difference is decreased, the maximum value of the ambiguous distance may be increased. However, when the frequency difference is decreased, the performance may be significantly degraded due to noise. In addition, considering that a prescribed range of frequencies are used in the wireless communication system, the problem of how the frequencies are apart should be solved. That is, the frequency range used in the system and the above-mentioned error are in the trade-off relationship, and thus a frequency to be used for the PDOA scheme can be selected in consideration of the frequency range and error. Moreover, when two frequencies are used, an error may be caused by the fade phenomenon for one of the two frequencies. Thus, the position measurement can also be performed using at least two frequencies, and details will be described later.

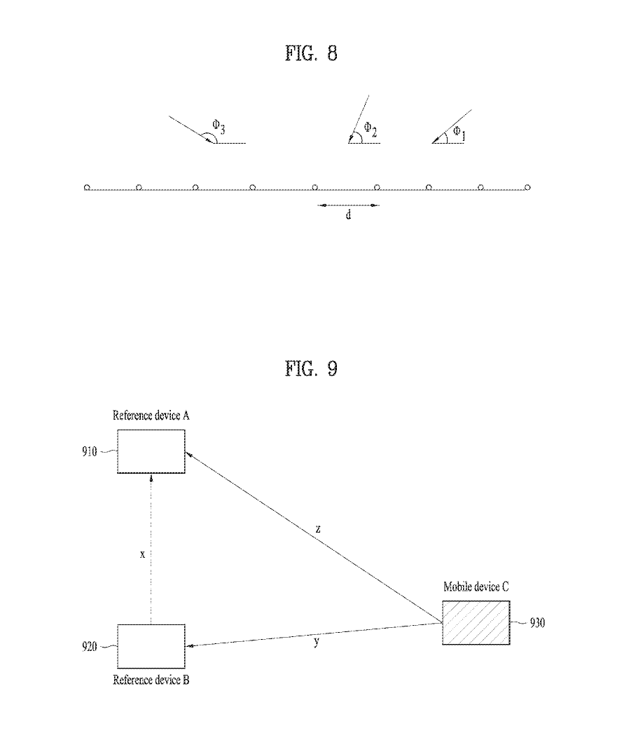

As a further example, the direction of arrival (DOA) scheme can be considered. Referring to FIG. 8, a plurality of signals M may have their own directions Øᵢ. According to the DOA scheme, signals received in the respective directions can be estimated, and then the estimated signals can be used to determine the directions. That is, it is possible to estimate and determine the signal direction from the received signal through the DOA scheme.

Hereinafter, a description will be given of a method for measuring a position based on the aforementioned PDOA scheme. In this case, for example, assuming that high frequency or resolution is used, it is more beneficial to perform the position measurement using phase information than to perform the position measurement using time differences. In addition, when the position measurement is performed using the phase information, a synchronization procedure between devices may not be required. For example, the aforementioned PDOA scheme can be applied to measure a distance difference among a plurality of unsynchronized wireless communication devices.

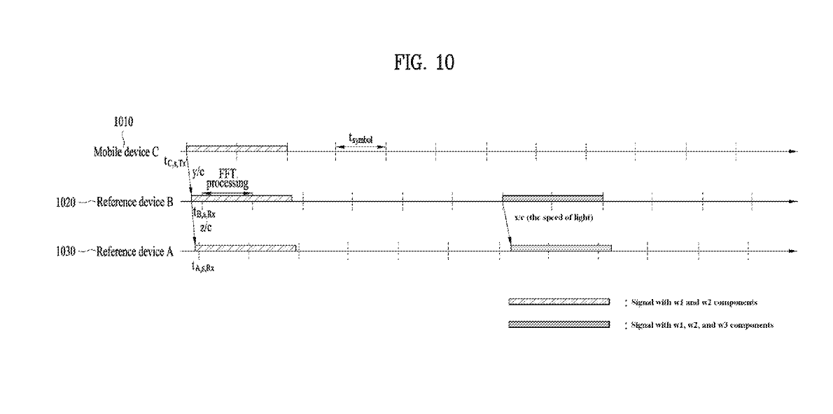

In detail, the position measurement can be performed using phase information of one-way signals as shown in FIG. 9. In this case, for example, when the number of frequencies used for transmission and reception is generalized or transmission and reception frequencies have different values, the position measurement can be performed using the phase information.

In addition, for example, even if that multiple frequencies are not simultaneously transmitted, the position measurement can be performed using the phase information. However, in consideration of an environment where signal transmission is performed or an error caused thereby, it is preferred to apply the PDOA scheme when signals are simultaneously transmitted, the invention is not limited thereto.

Moreover, for example, it is assumed that signals transmitted and received to and from all UEs are quantized. For example, when signals are transmitted and received based on OFDM, a boundary point of each OFDM symbol may be considered as a quantized time. However, the invention is not limited thereto.

Specifically, referring to FIG. 9, reference device A 910 and reference device B 920 are reference devices located at fixed positions, and each of them may be, for example, a base station, wireless relay, or wireless small cell. However, the invention is not limited thereto. In this case, mobile device C 930 is a UE of which a location is to be calculated. Since the reference devices 910 and 920 are located at the fixed positions, their positions may be known in advance. That is, the value of x, which is a distance difference between the reference device A 910 and reference device B 920 can be informed in advance. In addition, to obtain position information of the device C 930, information on y corresponding to a distance between the device C 930 and the reference device B 920 and information on z corresponding to a distance between the device C 930 and the reference device A 910 should be first known. In other words, by calculating the value of (z−y), it is possible to obtain the position information of the device C 930. In this case, a distance difference between the device C 930 and the reference devices 910 and 920 can be measured through phase information based on the above-described PDOA scheme.

FIG. 10 is a diagram illustrating a method for obtaining information on a distance between devices using phase information.

In this case, although all devices are assumed to be unsynchronized and transmitted and received signals are quantized as described above, the present invention is not limited thereto.

Referring to FIG. 10, individual devices 1010, 1020, and 1030 may perform OFDM processing using FFT or IFFT at different times. Although a transmitted signal configured with two repeated symbols is considered for convenience of description, it is possible to design a transmitted signal having a cyclic prefix (CP) and data, which has a length of one symbol. However, the invention is not limited thereto.

In detail, referring to FIG. 10, mobile device C 1010 can transmit distance measurement reference signals having frequencies of w1 and w2 (each of which is a reference signal for measuring a distance) at a time of tC,s,Tx. The distance measurement reference signals received by reference device B 1020 can be expressed as shown in Equation 5 and Equation 6.

E(w₁,t,C)=A(0)*exp(j*(w₁*(t−t_{C,s,Tx}))) [Equation 5]

E(w₂,t,C)=A(0)*exp(j*(w₂*(t−t_{C,s,Tx}))) [Equation 6]

In Equations 5 and 6, A(0) indicates an amplitude of a radio signal at a corresponding location. Since the device C 1010 and the reference device B 1020 are located apart by a distance y, the signals transmitted from the device C 1010 arrive at the reference device B 1020 at a time of t=t_{B,a,Rx}=t_{C,s,Tx}+y/c. Thus, the signals received by the reference device B 1020 can be expressed as shown in Equation 7 and Equation 8.

E(w₁,t,B)=A(d)*exp(j*(w₁*t−w₁*t_{C,s,Tx}−k₁*y)) [Equation 7]

E(w₂,t,B)=A(d)*exp(j*(w₂*t−w₂*t_{C,s,Tx}−k₂*y)) [Equation 8]

In this case, the condition of k=w/c can be satisfied, where c is the transmission velocity of the above-described signal or the speed of light. In this case, since the signals are quantized, the reference device B 1020 can process the received signals at a time of t=t_{B,s,Rx}. In addition, when FFT-based OFDM processing is applied, it is possible to represent signals with various frequencies, which are multiples of a basic frequency having an initial phase=0 at the time t=t_{B,s,Rx}, in the multiplication form. In this case, due to the FFT characteristics, the signals having the same frequencies as those of the received signals are remained. When multiplication is performed with respect to the remaining frequencies, it becomes 0 during addition. Therefore, as the FFT result, a value obtained by the receiving device with respect to the frequency component w1, X_{B,Rx}(w₁) can be expressed as shown in Equation 9.

X_{B,Rx}(w₁)=E(w₁,t,B)*exp(−j*w₁(t−t_{B,s,RX}))=A(d)*exp(j*(w₁*t−w₁*t_{C,s,TX}−k₁*y−w₁*t_{B,s,RX}))=A(d)*exp(j*(w₁*(t_{B,s,RX}−t_{C,s,TX})−k₁*Y)) [Equation 9]

Similarly, as the FFT result, a value obtained by the receiving device with respect to the frequency component w2, X_{B,Rx}(w₂) can be expressed as shown in Equation 10.

X_{B,Rx}(w₂)=A(d)*exp(j*(w₂*(t_{B,s,RX}−t_{C,s,TX})−k₂*y)) [Equation 10]

A ratio between the two components obtained through the FFT process can be expressed as shown in Equation 11.

$$\frac{{X}_{B , Rx} ( {w}_{2} )}{{X}_{B , Rx} ( {w}_{1} )} = exp ( j * ( ( {w}_{2} - {w}_{1} ) ( {t}_{B , s , RX} - {t}_{C , s , TX} ) - ( {k}_{2} - {k}_{1} ) * y ) )$$

In this case, a phase difference between the two frequency components can be expressed as shown in Equation 11.

$$arg ( B ) = arg ( \frac{{X}_{B , Rx} ( {w}_{2} )}{{X}_{B , Rx} ( {w}_{1} )} ) = ( {w}_{2} - {w}_{1} ) ( {t}_{B , s , RX} - {t}_{C , s , TX} ) - ( {k}_{2} - {k}_{1} ) * y \qquad [ Equation 11 ]$$

In addition, a phase difference between the frequency components w1 and w2 at the reference device A 1030 can be calculated through processes similar to those for the reference device B 1020, and it can be expressed as shown in Equation 12.

$$arg ( A ) = arg ( \frac{{X}_{A , Rx} ( {w}_{2} )}{{X}_{A , Rx} ( {w}_{1} )} ) = ( {w}_{2} - {w}_{1} ) ( {t}_{A , s , RX} - {t}_{C , s , TX} ) - ( {k}_{2} - {k}_{1} ) * z \qquad [ Equation 12 ]$$

In addition, referring to FIG. 10, the reference device B 1020 may transmit signals to the reference device A 1030 using w1, w2, and w3 at a time of t=t_{B,s,Rx}+n*t_{symb}.

In this case, the signals transmitted from the reference signal B 1020 at w1, w2, and w3 can be expressed as shown in Equations 13, 14, and 15, respectively.

R(w₁,t,B)=A(0)*exp(j*(w₁*(t−t_{B,s,Rx}−n*t_{symbol}))) [Equation 13]

R(w₂,t,B)=A(0)*exp(j*(w₂*(t−t_{B,s,Rx}−n*t_{symbol}))) [Equation 14]

R(w₃,t,B)=A(0)*exp(j*(w₃*(t−t_{B,s,Rx}−n*t_{symbol})+arg(B))) [Equation 15]

In this case, the reference device A 1030 may perform the FFT operation on the signals received from the reference device B 1020 at a quantized processing time of t=t_{A,s,Rx}+(n+1)*t_{symb} by multiplying signals each having the initial phase set to 0. By doing so, components obtained from the frequency components w1, w2, and w3 can be expressed as shown in Equations 16, 17, and 18, respectively.

X_{A,Rx}(w₁)=R(w₁,t,A)*exp(−j*w₁(t−t_{A,s,Rx}−(n+1)*t_{symb}))=A(a)*exp(j*(w₁(t_{A,s,Rx}−t_{B,s,Rx}+t_{symb})−k₁*x)) [Equation 16]

X_{A,Rx}(w₂)=A(a)*exp(j*(w₂(t_{A,s,Rx}−t_{B,s,Rx}+t_{symb})−k₂*x)) [Equation 17]

X_{A,Rx}(w₃)=A(a)*exp(j*(w₃(t_{A,s,Rx}−t_{B,s,Rx}+t_{symb})−k₃*x+arg(B))) [Equation 18]

In this case, t_{symb} may be a length of the OFDM symbol, and a distance between the reference devices A 1030 and B 1020, x may be fixed as described above. Thus, it is possible to calculate a value of (t_{A,s,Rx}−t_{B,s,Rx}) from a phase difference between components obtained from w1 and w2. Thereafter, it is also possible to calculate arg(B) using the value of (t_{A,s,Rx}−t_{B,s,Rx}) and a phase difference between components obtained from w2 and w3.

Further, according to Equations above, a difference between arg(A) and arg(B) can be expressed as shown in Equation 19.

arg(B)−arg(A)=(w₂−w₁)(t_{B,s,Rx}−t_{A,s,Rx})+(k₂−k₁)*(z−y) [Equation 19]

Thus, the distance difference, (z−y) between the device C 1010 and the reference devices A 1030 and B 1020 can be finally calculated, and it can be expressed as shown in Equation 20.

$$z - y = \frac{arg ( B ) - arg ( A ) - ( {w}_{2} - {w}_{1} ) ( {t}_{B , s , Rx} - {t}_{A , s , Rx} )}{( {k}_{2} - {k}_{1} )} \qquad [ Equation 20 ]$$

As another example, as described above, the reference device A 1030 should know the distance x between the reference devices A 1030 and B 1020 to calculated (z−y). In this case, even though the reference device B 1020 is fixed, the reference device A 1030 may not know the distance x. In other words, the reference device A 1030 should be able to calculate the distance x.

In this case, for example, before the device C 1030 transmits signals, the reference device A 1030 may transmit, to the reference device B 1020, a distance measurement reference signal using at least two subcarriers. In this case, the reference device B 1020 calculates phase information (68) for measuring the distance x through the subcarriers of the signal received from the reference device A 1030. Thereafter, when the reference device B 1020 transmits, to the reference device A 1030, phase information on the signal received from the device C 1010, the reference device B 1020 may add one reference signal to transmit the obtained phase information (δ₁). By doing so, the reference device A 1030 can calculate the distance x between the reference devices A 1030 and B 1020 through

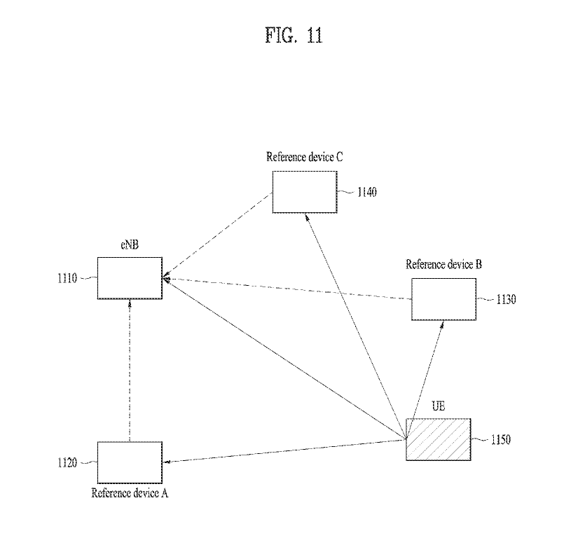

FIG. 11 is a diagram illustrating a method for performing position measurement using a plurality of reference devices.

Referring to FIG. 11, a position of a UE 1150 can be obtained using multiple reference devices 1110, 1120, 1130, and 1140 placed at predetermined positions in a single cell. To this end, for example, The UE 1150 can broadcast a PDOA reference signal (RS) to the reference devices 1120, 1130, and 1140 and the eNB 1110. Thereafter, each of the reference devices 1120, 1130, and 1140 can measure PDOA of the signal received from the UE 1150 and then transmit the measured PDOA information to the eNB 1110 through an RS. The eNB 1110 can calculate the position of the UE 1150 using PDOA of the signal received from the UE 1150 and the PDOA transmitted from each of the reference devices. Specifically, the eNB 1110 can calculate the position of the UE 1150 from an intersection point of hyperbolic curves formed by “(eNB 1110—reference device A 1120—UE 1150), (eNB 1110—reference device B 1130—UE 1150), and (eNB 1110—reference device C 1120—UE 1150).

Accordingly, the performance of the position measurement can be improved compared to the conventional positioning method (e.g., UTDOA).

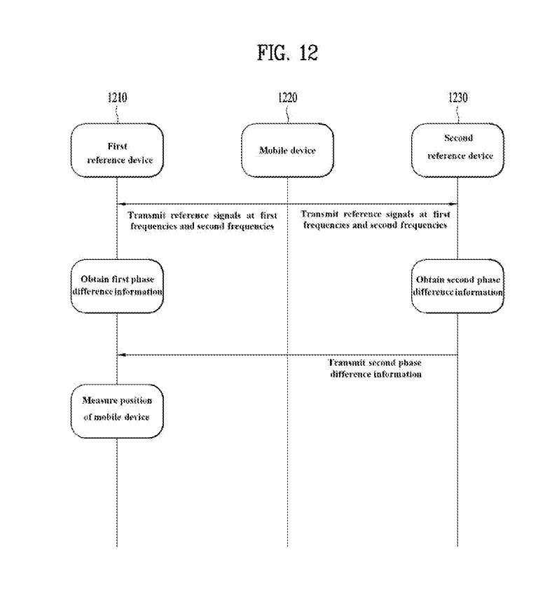

FIG. 12 is a diagram illustrating a method performed by reference devices for measuring a position of a mobile device. The reference device may be a device located at a fixed as described above, an eNB, or relay device as described above. Alternatively, the reference device may be a device of which a position is determined. The mobile device may be a device that can move or another type of device.

In the related art, for example, the eNB transmits a PRS, and the device transmits a UL signal to the eNB. By doing so, the eNB can measure a position of the device. The aforementioned UTDOA scheme may be considered as a representative example.

In this case, for example, a position of the mobile device can be measured without using a method in which the reference device transmits and receives signals to and from the mobile device. That is, the reference device can measure the position of the mobile device using a one-way signal transmitted from the mobile device instead of exchanging signals with the mobile device. In this case, the mobile device can transmit distance reference signals to the reference device at different frequencies (or tones) as described above. In addition, the reference device can measure the position of the mobile device using phase difference information of the distance reference signals transmitted at the different frequencies.

In the related art, the position measurement is performed using, for example, a time difference. However, in this case, an error in the time difference may be increased according to a sampling rate. That is, when a phase difference is used, resolution is increased, and thus accuracy in distance measurement is increased. In addition, for example, when the phase difference is used, accuracy in the position measurement is increased as a difference between different frequencies is increased. However, difference frequency bands can be used in consideration of frequency bands used in devices. Moreover, for example, since when a high frequency band is used, a difference between frequency bands may be increased, the accuracy in the position measurement using the above-described phase difference information may be improved as described above.

Referring to FIG. 12, a mobile device 1220 can transmit reference signals to a first reference device 1210 and a second reference device 1230. In this case, for example, the reference signals may be distance measurement reference signals. In addition, the mobile device 1220 may transmit the reference signals at first and second frequencies. In other words, the mobile device 1220 may transmit, to the first reference device 1210, the reference signals at the first and second frequencies. In addition, the mobile device 1220 may transmit, to the second reference device 1230, the reference signals at the first and second frequencies.

In this case, the first reference device 1210 can measure a position of the mobile device 1220. That is, since the position measurement is performed through the one-way signals transmitted from the mobile device 1220, delay and overhead due to signal exchange can be reduced.

When the first reference device 1210 receives, from the mobile device 1220, the reference signals at the first and second frequencies, the first reference device 1210 can obtain first phase difference information through the reference signals based on the first and second frequencies, and in this case, the first phase difference information can be determined according to above Equations.

In addition, the second reference device 1230 can obtain second phase difference information using the reference signals received from the mobile device 1220 at the first and second frequencies.

Thereafter, the second reference device 1230 can transmit the second phase difference information to the first reference device 1210. The first reference device 1210 can measure the position of the mobile device 1220 based on the information received from the second reference device 1230 and the first phase difference information. In this case, as described above, the first reference device 1210 can obtain a distance between the mobile device 1220 and the first reference device 1210 and a distance between the mobile device 1220 and the second reference device 1230 using the first and second phase difference information. In addition, the first reference device 1210 can measure the position of the mobile device 1220 based on information on the distance difference as described above.

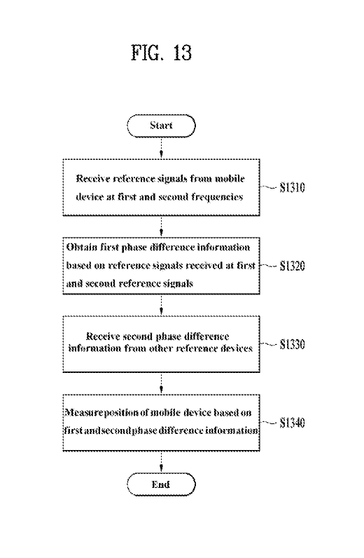

FIG. 13 is a flowchart illustrating a method for measuring a position of a mobile device.

A reference device can receive, from a mobile device, reference signals at first and second frequencies [S1310]. In this case, as described with reference to FIGS. 1 to 12, the reference device may be a device located at a fixed position or a device of which a location is known. In addition, for example, the reference device may be an eNB as described above.

Next, the reference device can obtain first phase difference information based on the reference signal received at the first frequency and the reference signal received at the second frequency [S1320]. In this case, as described with reference to FIGS. 1 to 12, the first phase difference information may be information generated based on a frequency difference. In this case, the reference device may obtain the phase difference information for the reference signals based on above Equations as described above. In addition, other reference devices can obtain the reference signals at the first and second frequencies as described above. In this case, for example, the number of other reference devices may be one or plural. That is, the position of the mobile device can be measured using two or more reference devices as described above.

In this case, the other reference devices can also obtain the phase difference information using the frequency difference between the signals transmitted from the mobile device.

Next, the reference device can receive the second phase difference information from the other reference devices [S1330]. In this case, as described with reference to FIGS. 1 to 12, the reference device can measure the position of the mobile device using its phase difference information and the other reference devices' phase difference information. In this case, for example, the reference device can reference the phase difference information from a plurality of reference devices. By doing so, the reference device can improve accuracy in the position measurement for the mobile device. However, the invention is not limited thereto.

Thereafter, the reference device can measure the position of the mobile device based on the first and second phase difference information [S1340]. In this case, as described with reference to FIGS. 1 to 12, the reference device can obtain information on distances among the mobile device and each of the reference devices based on the first and second phase difference information. In detail, distance difference values among the mobile device and each of the reference devices can be obtained according to above Equations. Thereafter, the reference device can measure the position of the mobile device using information on the distance difference values among the mobile device and each of the reference devices. In this case, for example, since the reference devices are fixed as described above, distances among the reference devices can also be fixed. In addition, for example, the reference device can perform the process for calculating the distances among the reference devices as described above. Thereafter, the reference device can measure the position of the mobile device using the distances among the reference devices and the information on the distance difference values among the mobile device and each of the reference devices as described above.

The embodiments of the present invention mentioned in the foregoing description can be implemented using various means. For instance, the embodiments of the present invention can be implemented using hardware, firmware, software and/or any combinations thereof.

When implemented as hardware, a method according to embodiments of the present invention may be embodied as one or more application specific integrated circuits (ASICs), one or more digital signal processors (DSPs), one or more digital signal processing devices (DSPDs), one or more programmable logic devices (PLDs), one or more field programmable gate arrays (FPGAs), a processor, a controller, a microcontroller, a microprocessor, etc.

When implemented as firmware or software, a method according to embodiments of the present invention may be embodied as a module, a procedure, or a function that performs the functions or operations described above. Software code may be stored in a memory unit and executed by a processor. The memory unit is located at the interior or exterior of the processor and may transmit and receive data to and from the processor via various known means.

Preferred embodiments of the present invention have been described in detail above to allow those skilled in the art to implement and practice the present invention. Although the preferred embodiments of the present invention have been described above, those skilled in the art will appreciate that various modifications and variations can be made in the present invention without departing from the spirit or scope of the invention. For example, those skilled in the art may use a combination of elements set forth in the above-described embodiments. Thus, the present invention is not intended to be limited to the embodiments described herein, but is intended to accord with the widest scope corresponding to the principles and novel features disclosed herein. The present invention may be carried out in other specific ways than those set forth herein without departing from the spirit and essential characteristics of the present invention. Therefore, the above embodiments should be construed in all aspects as illustrative and not restrictive. The scope of the invention should be determined by the appended claims and their legal equivalents, and all changes coming within the meaning and equivalency range of the appended claims are intended to be embraced therein. The present invention is not intended to be limited to the embodiments described herein, but is intended to accord with the widest scope consistent with the principles and novel features disclosed herein. In addition, claims that are not explicitly cited in each other in the appended claims may be presented in combination as an embodiment of the present invention or included as a new claim by subsequent amendment after the application is filed.

In addition, both an apparatus invention and a method invention are explained in the present specification, and if necessary, the explanation on both the inventions can be complementally applied.

What is claimed is:

1. A method for measuring a position of a mobile device by a reference device in a wireless communication system, the method comprising:
receiving, by a first reference device, reference signals at first and second frequencies from the mobile device;
obtaining first phase difference information based on the reference signals received at the first and second frequencies;
receiving, by the first reference device, second phase difference information from a second reference device; and
measuring the position of the mobile device based on the first and second phase difference information.

2. The method of claim 1, wherein the second reference device receives the reference signals at the first and second frequencies from the mobile device, and wherein the second reference device obtains the second phase difference information based on the reference signals received at the first and second frequencies.

3. The method of claim 1, wherein when a distance between the first reference device and the mobile device has a first value and a distance between the second reference device and the mobile device has a second value, a difference between the first and second values is determined based on the first and second phase difference information.

4. The method of claim 3, wherein the position of the mobile device is determined based on the difference between the first and second values.

5. The method of claim 1, wherein each of the reference signals is a reference signal for measuring a distance.

6. The method of claim 1, wherein the first phase difference information is information generated based on a difference between the first and second frequencies.

7. The method of claim 1, wherein the reference device is a device with a fixed location.

8. The method of claim 1, wherein the reference device is an evolved node B (eNB).

9. A first reference device for measuring a position of a mobile device in a wireless communication system, the reference device comprising:
a receiver configured to receive a signal;
a transmitter configured to transmit a signal; and
a processor controlling the receiver and transmitter,
wherein the processor is configured to:
receive reference signals at first and second frequencies from the mobile device using the receiving mode,
obtain first phase difference information based on the reference signals received at the first and second frequencies,
receive second phase difference information from a second reference device using the receiving mode, and
measure the position of the mobile device based on the first and second phase difference information.

10. The reference device of claim 9, wherein the second reference device receives the reference signals at the first and second frequencies from the mobile device, and wherein the second reference device obtains the second phase difference information based on the reference signals received at the first and second frequencies.

11. The reference device of claim 9, wherein when a distance between the first reference device and the mobile device has a first value and a distance between the second reference device and the mobile device has a second value, a difference between the first and second values is determined based on the first and second phase difference information.

12. The reference device of claim 11, wherein the position of the mobile device is determined based on the difference between the first and second values.

13. The reference device of claim 9, wherein each of the reference signals is a reference signal for measuring a distance.

14. The reference device of claim 9, wherein the first phase difference information is information generated based on a difference between the first and second frequencies.

15. The reference device of claim 9, wherein the reference device is a device with a fixed location.
